(19) United States
(12) Patent Application Publication
(10) Pub. No.: US 2012/0085503 A1
(43) Pub. Date: Apr. 12, 2012

(54) Window covering for an architectural opening

(76) Inventor: Jay S. Kotin, Irvine, CA (US)

(21) Appl. No.: 13/373,229

(22) Filed: Nov. 8, 2011

Related U.S. Application Data
(63) Continuation-in-part of application No. 12/925,006, filed on Oct. 12, 2010.

(51) Int. Cl. E06B 9/36; E06B 7/086; E06B 9/28; E06B 9/386; E06B 9/26

(52) U.S. Cl. 160/174 V; 160/236; 160/174 R; 49/92.1

(57) ABSTRACT

A window covering louvered blind system for horizontal and vertical orientations has a plurality of structurally sound and aesthetically appealing louvers within the body of the window-covering unit, creating the look of soft fabric roman shades. A primary main body or middle segment of the louver is substantially planar, radiused or curvilinear with at least one fin which may be tapered and that extends from the elongated edge of the main body at a continuous obtuse angle. In some versions two opposed fins extend integrally in the same downward direction from the elongated edges of the main body at an obtuse angle. The preferred embodiments have a matching head-rail and bottom rail designed to neatly nest the louvers above it. Both symmetrical and asymmetrical versions of fins are disclosed. The louvers hereof are shown being used in blinds and shutters.

### CROSS-REFERENCE TO RELATED APPLICATIONS

This application is a continuation-in-part of application Ser. No. 12/925,006 filed on Oct. 12, 2010.

### BACKGROUND OF THE INVENTION

2. Field of the Invention

This invention relates to an improved vane system for use in horizontal or vertical blinds and horizontal and vertical shutters, which may be used to cover an architectural opening in a building.

2. Background Art

Window blinds have been used for centuries to cover openings and to provide light control in buildings. Horizontal, or Venetian blinds and shutters, as well as vertical blinds are commonly comprised of a plurality of flat, coved, or S-shaped wood, plastic, fabric or metal vanes or louvers that hang from hardware, which enables the vanes to be tilted to control light.

Venetian blind systems include an upper head-rail control unit that is installed into or over an architectural opening. Suspended down from this unit are at least two lift cords as well as at least two ladder-like configurations that hold the vanes or louvers a predetermined distance from each other in parallel. The lift cords, (wires, tapes, etc.) may be placed through rout holes, (oblong notches) in each slat to secure the slat to the blinds, or they may be placed through braided loops that are woven into the vertical walls of the ladder tapes, running through notches that have been placed through the edges of the vanes. The lift cords are attached at the bottom of the unit to a bottom rail, which hangs within the ladders below the last louver. Pulling on the lift cords raises the blind, and the blind may be locked into position by means of a cord lock that the cords pass through and which is located within the head-rail. The louvers may also be tilted to control light by means of a tilting mechanism, which is suspended from the head-rail. Raising, lowering, traversing and tilting may also be accomplished by means of various motorized and other industry recognized “cordless” mechanisms.

U.S. Patents showing shaped vanes for blinds, include the following:
U.S. Pat. No. 2,121,217
U.S. Pat. No. 2,155,985
U.S. Pat. No. 2,209,355
U.S. Pat. No. 3,916,973
U.S. Pat. No. 4,236,566
U.S. Pat. No. 5,657,806
U.S. Pat. No. 5,957,183
U.S. Pat. No. 6,371,193
U.S. Pat. No. D495,549
   and published applications 2005/0230063 and 2008/0093036 also show vane shapes.

### SUMMARY OF THE INVENTION

The present invention comprises a set of blinds wherein each vane or louver is uniquely configured to have a cross-section which provides superior resistance to bending, enabling the vane to traverse a greater span without bow and camber and better light control than conventional vanes or louvers. Another benefit is that the mid-section of the vane can be thinner and therefore lighter than a conventional vane while providing superior dimensional stability. Thinner and lighter vanes equate to lower cost of the vane and less stress on lifting and traversing hardware systems. Vanes and louvers may be constructed utilizing polymers, wood, metal and other materials that have characteristics that are suitable for window coverings.

Several preferred embodiments are disclosed herein. Each such embodiment employs a vane having a cross-section providing a planar, radiused or curvilinear, middle section and at least one fin extending downward integrally from the edge of the middle section in a direction which forms a continuous obtuse angle relative to the middle section. When employing two fins, they extend from opposite edges of the middle section, each in a direction which forms an obtuse angle relative to the middle section. In one embodiment, a single fin extends downward from the back of the vane. In another embodiment, a single fin extends from the front of the vane. In yet another embodiment, two fins are identical to one another to form a symmetrical vane cross-section. In another embodiment the fins are different from each other to form an asymmetrical cross-section. In the disclosed asymmetrical embodiment, the fins are of different length. Fins may be of different obtuse angles and lengths creating different aesthetic looks and different various degrees of overall dimensional stability. Moreover, in each embodiment the fins may be tapered along at least a portion of their length. In addition, the fins may be curved or angled along at least a portion of their length.

It has been found that the combination of a planar, radiused or curvilinear middle section extending integrally into opposed curved and tapered fins, results in vanes which are more resistant to bending, have better deflection properties which results in better control and which provides unique and advantageous aesthetic effects. In one embodiment, the design of the fin and the cross-section projects the appearance of a “Roman Shade-like” vane. When fully assembled, this design has the aesthetic appearance of a “soft fabric roman shade”, with the benefits of the light control and stacking properties of a blind. It has also been found that the use of a head-rail and a bottom rail that are each shaped to have a predominant surface characteristic that replicates the face of the vane cross-section, is also advantageous aesthetically and for efficient and tailored nesting of vanes, which provides superior and more attractive stacking when the unit is lifted or traversed to the closed position.

As used herein the term vanes, slats and louvers are interchangeable and refer to the individual elements of blinds and shutters that control the level of light that may pass or be blocked by a window covering unit. Such elements may be either vertical or horizontal so that each such term should be deemed to include both vertical and horizontal blinds as well as vertical and horizontal shutters.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of horizontal blinds in accordance with one preferred embodiment of the present invention;

FIG. 2 is a three-dimensional view of a symmetrical version of a vane for use in the unit of blinds of FIG. 1;

FIG. 3 is a front plan view of the vane of FIG. 2;

FIG. 4 is a rear plan view of the vane of FIG. 2;

FIG. 5 is a front edge view of the vane of FIG. 2;

FIG. 6 is a rear edge view of the vane of FIG. 2;

FIG. 7 is a left side view of the vane of FIG. 2;

FIG. 8 is a right side view of the vane of FIG. 2;

FIG. 9 is a three-dimensional view of an asymmetrical version of a vane for use in the set of blinds of FIG. 1;

FIG. 10 is a front plan view of the vane of FIG. 9;

FIG. 11 is a rear plan view of the vane of FIG. 9;

FIG. 12 is a front edge view of the vane of FIG. 9;

FIG. 13 is a rear edge view of the vane of FIG. 9;

FIG. 14 is a left side view of the vane of FIG. 9;

FIG. 15 is a right side view of the vane of FIG. 9;

FIGS. 16 and 17 illustrate the bottom rail of the asymmetrical version of a preferred embodiment and the nesting of a corresponding vane therewith;

FIGS. 18 and 19 illustrate the bottom rail of the symmetrical version of a preferred embodiment and the nesting of corresponding of a corresponding vane therewith;

FIGS. 20 and 21 show respective edge views of a head-rail for asymmetric and symmetric vanes, respectively;

FIGS. 22 and 23 show edge view of open and substantially closed configurations of the asymmetrical vane blinds;

FIGS. 24 and 25 show edge views of open and substantially closed configurations of the symmetrical vane blinds;

FIGS. 26 and 27 show the three-dimensional views of vertical and shutter versions of the present invention;

FIGS. 28 through 37 provide cross-sectional views of various alternative embodiments of inventive vanes; and

FIG. 38 provides a view of still another embodiment wherein each vane has ladder notches in the fins and an oval cord notch in the main body of the vane.

### DETAILED DESCRIPTION OF PREFERRED EMBODIMENTS

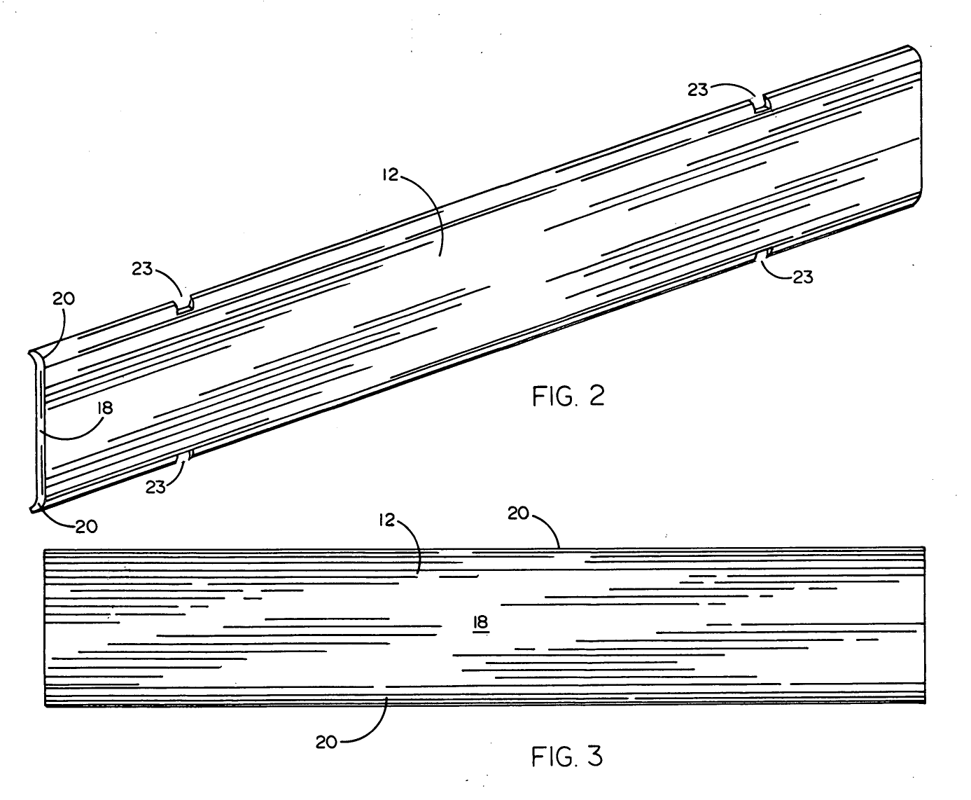

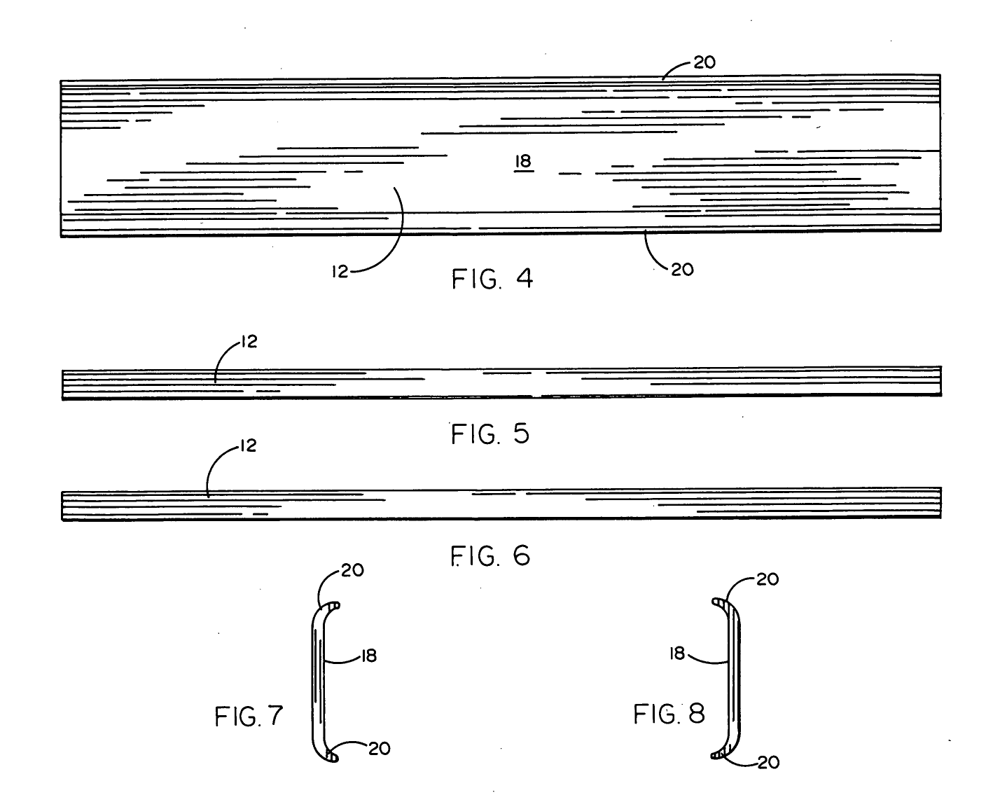

Referring to the accompanying drawings, it will be seen that the invention hereof, according to one embodiment, comprises a set of vanes or louvers. It is actually comprised of a blind assembly 10 which has a plurality of horizontally arranged louvers, vanes or slats 12. The vanes are configured in parallel and are tiltable by a pair of control cords 14 to either permit light to pass between the vanes or be blocked by the vanes. A pull cord 21 permits raising and lowering of the louvers, vanes or slats and securing them at any position between the top and bottom of the opening. Pulling the cord completely down, would enable the louvers to totally stack and nest under the headrail. The vanes are unique in their shape as characterized by their cross-section. In one embodiment shown best in FIGS. 2-8, the vanes 12 have what is referred to herein as a symmetric cross-section. Each such symmetrical vane 12 has a planar middle section 18 and a pair of opposed fins 20 extending integrally from opposite elongated edges of the vane's middle section. Each vane 12 is curved and tapered as shown best in FIGS. 7 and 8. Each vane provides a narrow notch 23 at or near its opposed ends to receive a set of louver ladder-like control strings 35. Unlike conventional vanes, the notches are provided only in the fins 20, not in the middle section 18.

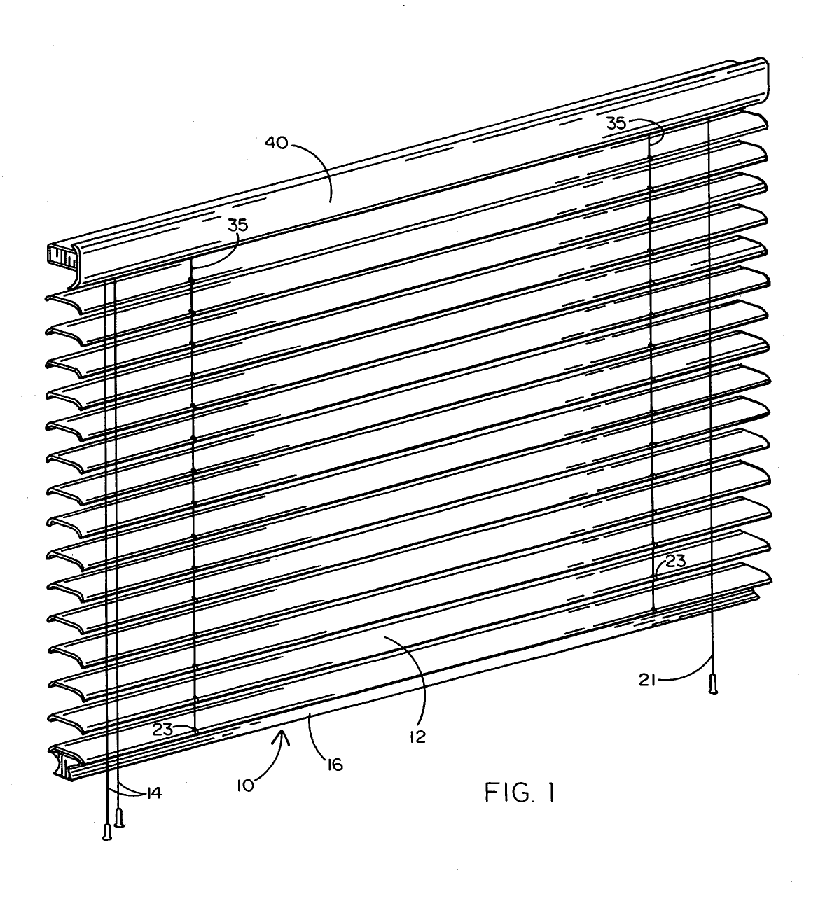

The principal advantage of such a cross-section is that the vane becomes more resistant to bending and has greater deflection properties than standard vanes so they can therefore be longer between vertical supports, without increasing the thickness of the main cross section. In horizontal shutters, which are attached at either end of the louver without the benefit of additional vertical supports, greater deflection properties are a desired feature. Louvers orientated vertically in vertical blinds and vertical shutters depend on the dimensional stability of the design to determine the maximum length that the louvers can be manufactured. These improved louver designs maximize these properties. However, that is not the only benefit of employing such a cross-section. Another significant advantage of the use of obtuse angled fins is the improved blockage of light entering between the tilted vanes. Still another advantage is achieved aesthetically in having a uniquely sculptured appearance resulting from the shape of the vanes. Moreover, the blinds of FIG. 1 employ a unique head-rail and bottom rail, each designed to add to the aesthetic and functional benefit of the vanes. The bottom rail 16, shown best in FIGS. 18 and 19, is shaped to match the cross-section of the vane 12 for both improved appearance and for easier lifting and improved nesting. The head-rail 40 has a face member 42 which carries through the shape of the vane for a more uniform appearance on the assembled unit and a bracket member 44 to facilitate connection to a wall bracket (not shown).

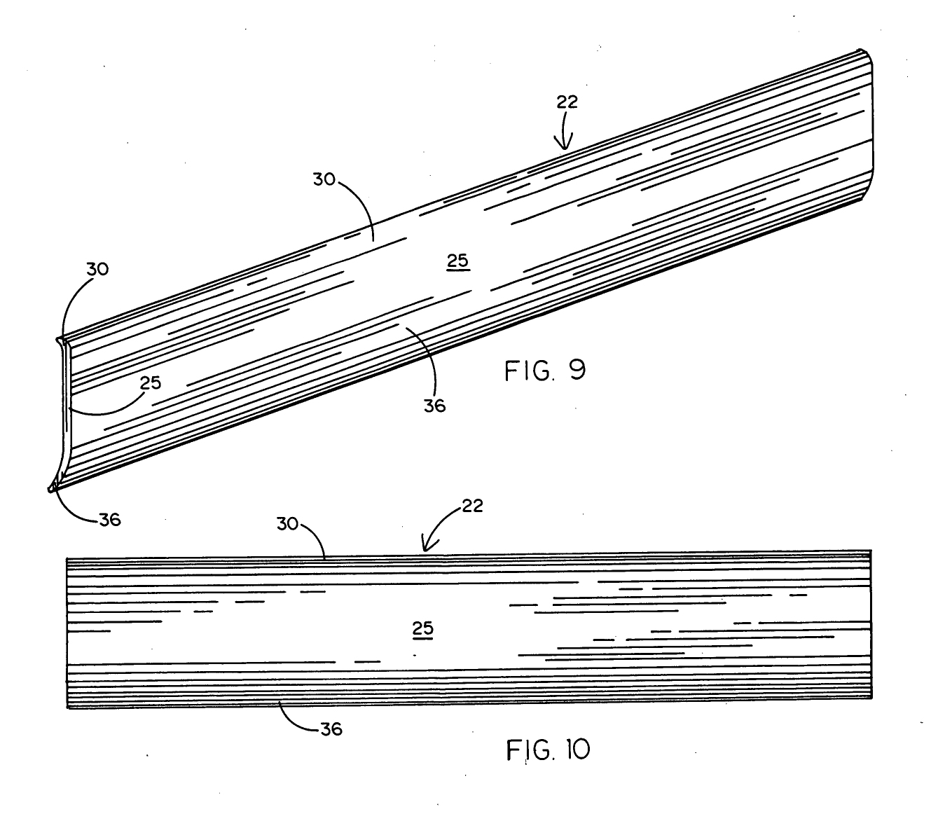

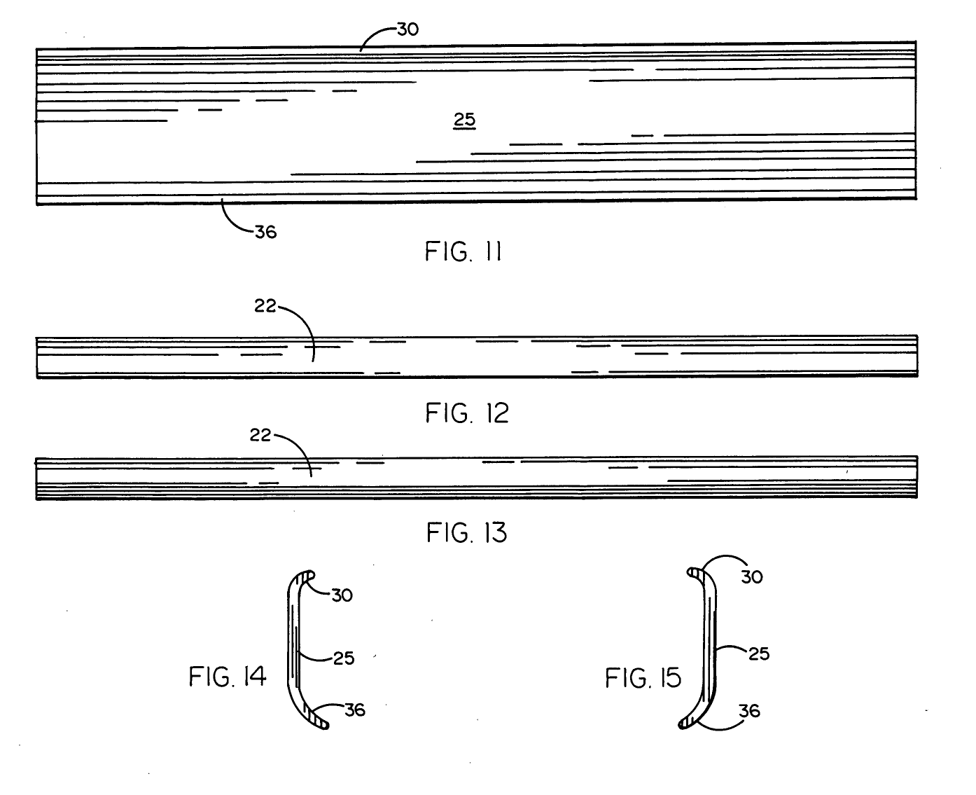

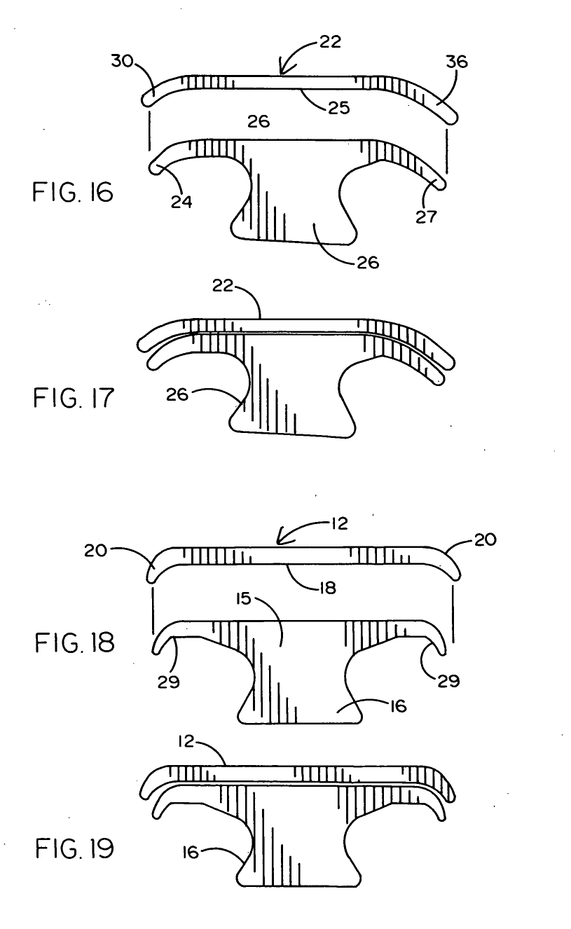

In a second embodiment, shown in FIGS. 9 to 15, the vanes or slats 22 are asymmetrical having a planar middle portion 25 and two different fins 30 and 36. Fin 30 has substantially the same shape and dimensions as the symmetrical fins 20 of the first embodiment. However, fin 36 while also being curved and tapered, has a greater length and therefore a longer taper, as well as a more gradual curve as seen best in FIGS. 14 and 15. The bottom rail 26 (see FIGS. 16 and 17) of the asymmetrical vane embodiment, has a planar middle portion 28 and fins 24 and 27, the former being shorter than the latter to comport with the unequal length fins 30 and 36 of vane 22 and thus also provides good nesting and an aesthetically pleasing uniformity. This design projects the appearance of a “Roman Shade-like” vane. When fully assembled, this design has the aesthetic appearance of a “soft fabric roman shade” with the benefits of the light control and stacking properties of a blind.

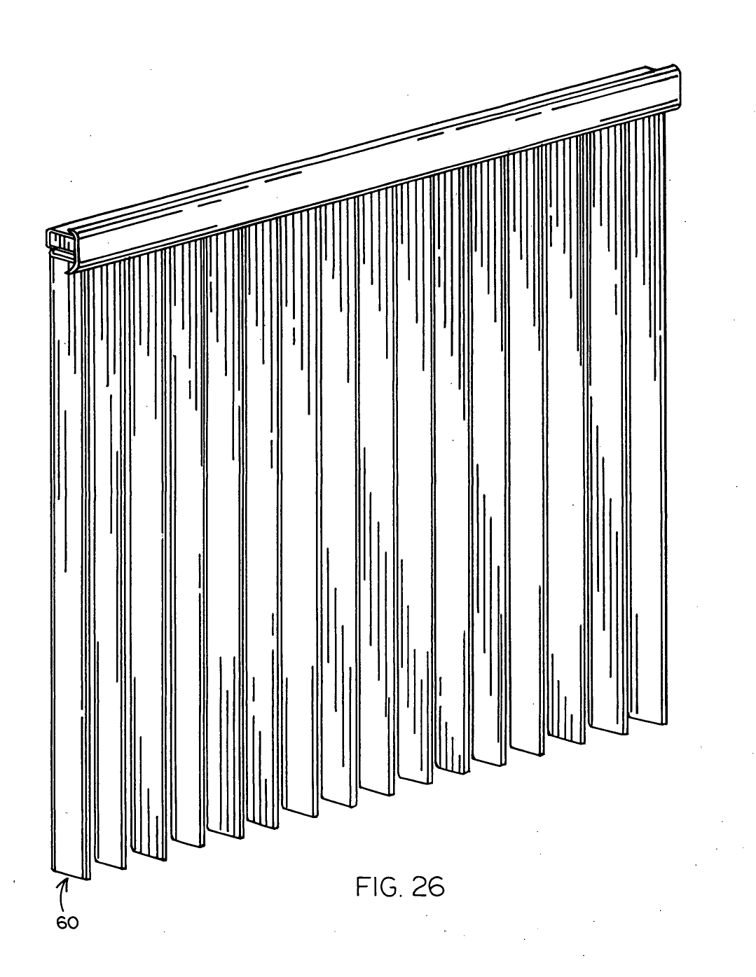

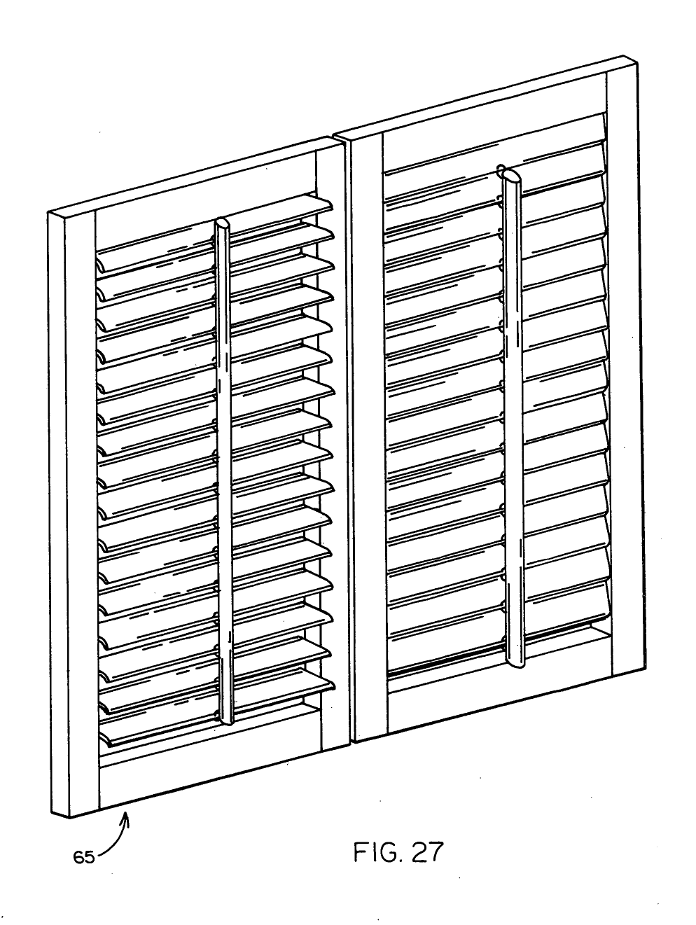

FIGS. 26 and 27 show other embodiments of the present invention, namely, vertical blinds 60 and horizontal shutters 65 using the unique louvers disclosed herein.

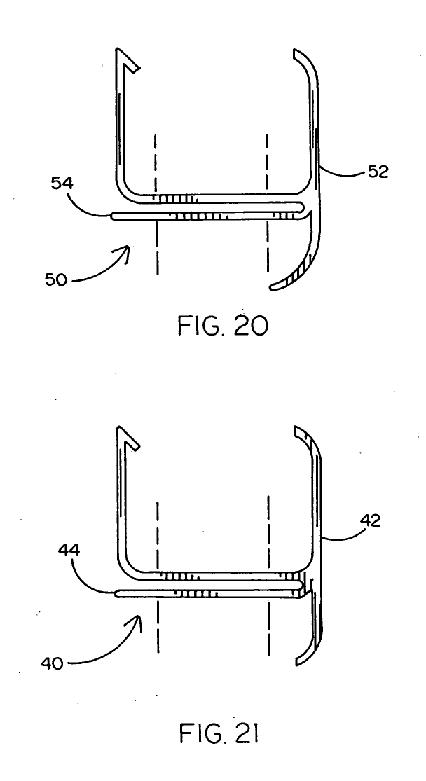

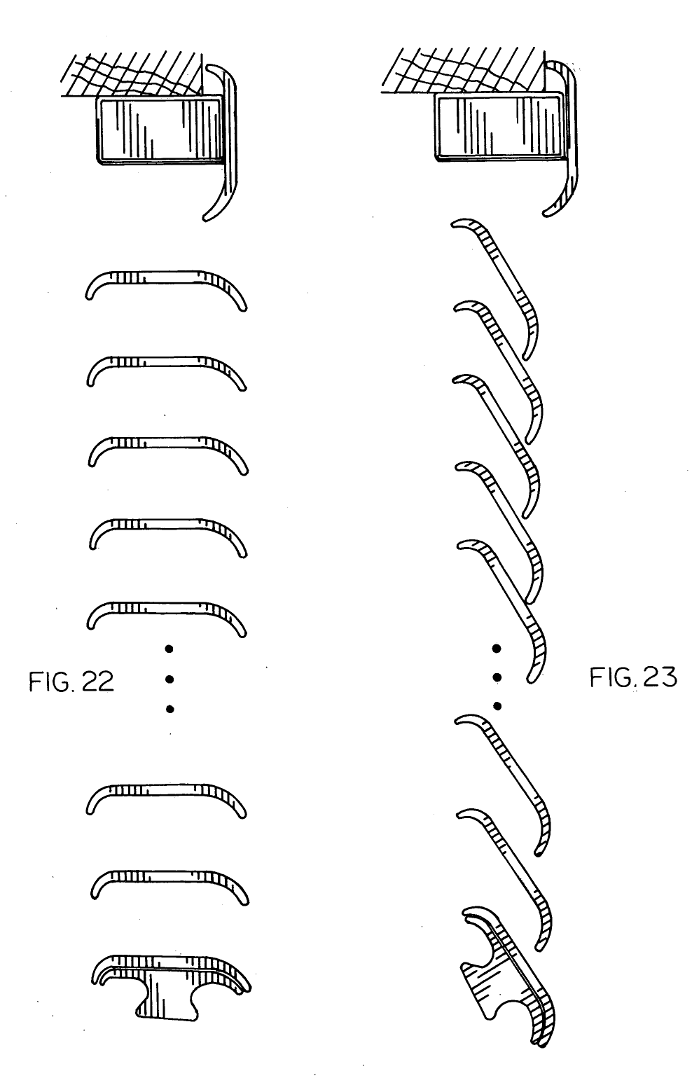

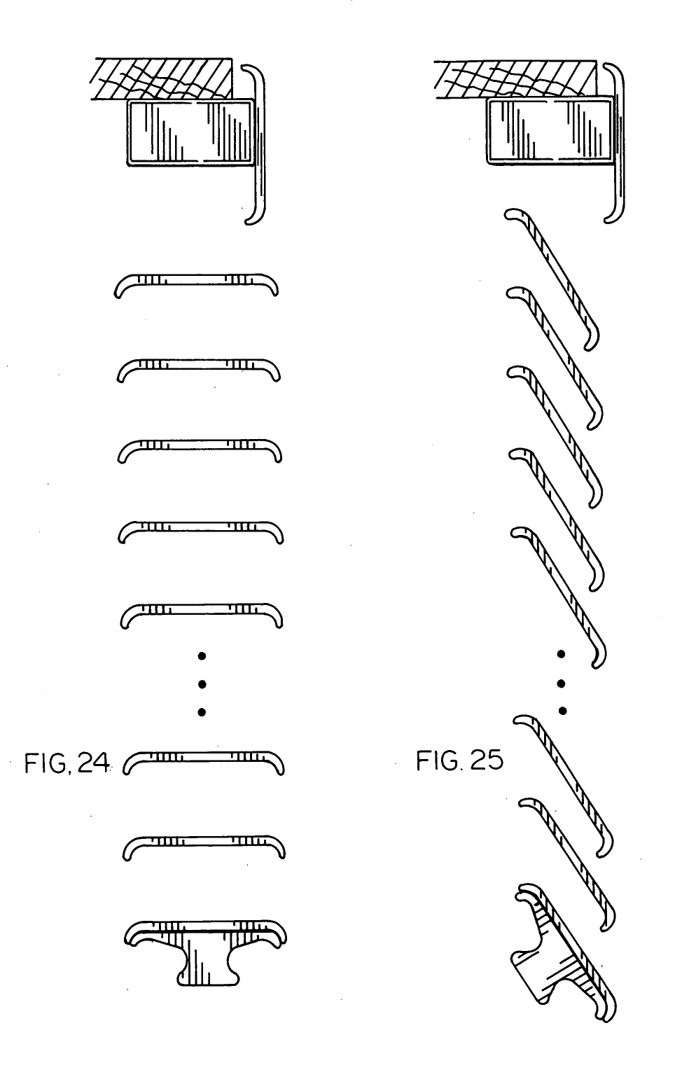

This embodiment also has a corresponding head-rail 50 (see FIG. 20) which includes an asymmetrical face 52 otherwise configured like head-rail 40 and bracket member 54 to connect the head-rail to a wall bracket (not shown).

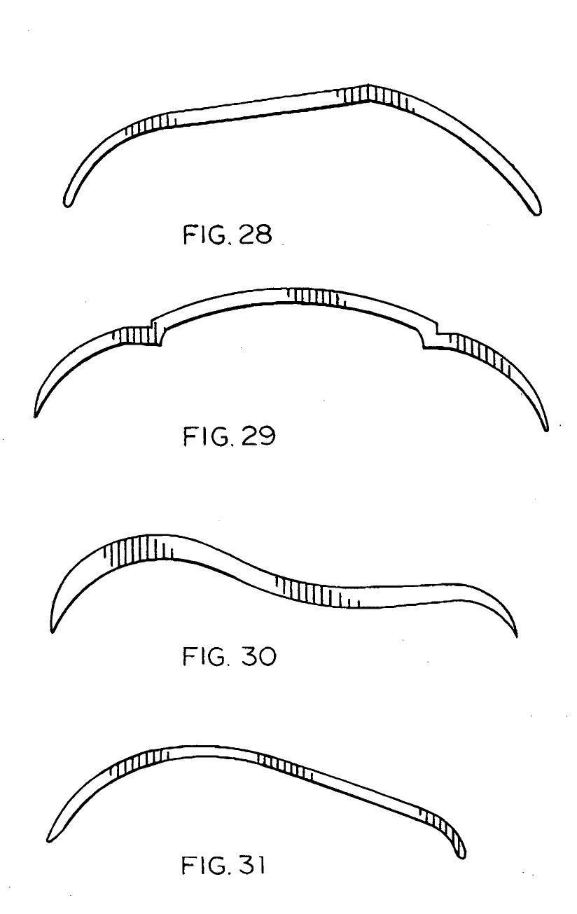

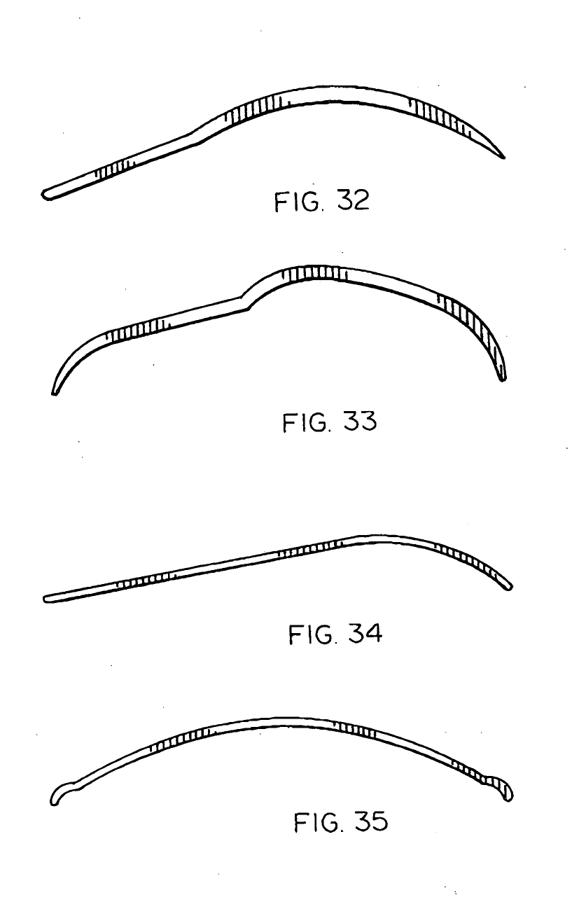

FIGS. 28 to 37 illustrate various alternative vane cross-sections which provide a variety of different overall blind or shutter aesthetics. FIG. 28 shows a version of a vane having non-symmetrical, non-tapered curved fins extending from an angled planar mid-section. FIG. 29 shows a vane version wherein symmetrical fins and mid-section are each curved with groove-like steps therebetween. FIG. 30 is an S-curve version with unequal convex fins extending integrally from a concave mid-section. FIG. 31 is similar to that of FIG. 28, but with a shorter, more abrupt tapered back vane and a more gradual transition to a larger tapered front fin. In the vane of FIG. 32, a longer non-tapered, shallower planar front fin merges to a curved mid-section and a smaller curved tapered rear fin. The vane of FIG. 33 is similar to that of FIG. 32, but has an abrupt tapered front fin end.

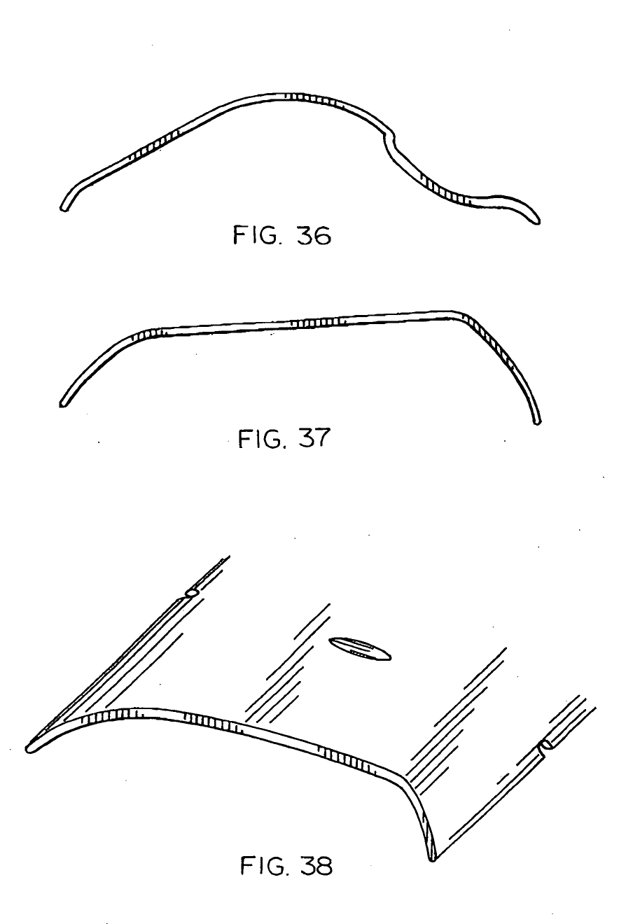

The vane of FIG. 34 has no back fin and a planar angled mid-section merging into a large prominent front fin. The vane of FIG. 35 is similar to that of FIG. 29, but with smaller radius and shorter symmetrical fins. FIG. 36 shows a vane with a partially flat and partially S-curved mid-section and short flat fins. FIG. 37 shows a vane that is similar to that of FIG. 28, but with a longer front fin that extends below the end of the rear fin. Finally, FIG. 38 shows a generic vane with an oval or oblong cord notch in the mid-section of the vane.

It will now be evident from the disclosure herein, that the present invention pertains to a novel set of window-covering blinds or shutters which may be either vertically or horizontally oriented and has a set of uniquely configured louvers. Each such louver has an advantageous new cross-section comprising a planar, radiused or curvilinear middle portion and at least one fin extending integrally downwardly from the elongated edge of the middle portion at a continuous obtuse angle. One or both fins may be tapered. This unique cross-section provides greater deflection properties, and bending resistance which increases the distance permitted between vane control supports. It also provides improved light blocking for example for darkening a room interior during daylight hours. Furthermore, it has aesthetic advantages not known in conventional blinds. A compatible head-rail and bottom rail also contribute to the aesthetics of the blinds hereof.

I claim:

1. A louver for use in window blinds, and shutters, the louver having a cross-section comprising:
a middle section; and
opposed continuous fins extending from opposite elongated edges of said middle section, each said fin extending in a direction that is at an obtuse downward angle relative to said middle section;
said fins each extending integrally from said middle section.

2. The louver of claim 1 wherein each of said fins is identical to the other to form a symmetrical cross-section.

3. The louver of claim 1 wherein each of said fins is different from the other in at least its length, to form an asymmetrical cross-section.

4. The louver of claim 1 wherein at least one of said fins is tapered along at least a portion of its length.

5. The louver of claim 1 wherein at least one of said fins is curved.

6. Window-covering blinds having simultaneously tiltable vanes extending between a head-rail and a bottom rail; the blinds comprising:
a plurality of said tiltable vanes configured in parallel arrangement and spaced to selectively provide either transmission of light between said vanes or substantial blockage of light therebetween depending on the angle of tilt of said vanes;
said head-rail having at least one visible member having a cross-section substantially identical to each said vane;
said bottom rail having at least one member shaped for nesting engagement with said vanes;
each vane having a cross-section formed by a middle section and at least one continuous fin extending from an elongated edge of said middle section, said at least one fin extending in a direction that forms an obtuse angle relative to said middle section and extending integrally therefrom.

7. The blinds of claim 6 wherein there are two of said fins and each of said fins is identical to the other to form a symmetrical cross-section.

8. The blinds of claim 6 wherein there are two of said fins each of said fins is different from the other in at least its length, to form an asymmetrical cross-section.

9. The blinds of claim 6 wherein said at least one fin is tapered along at least a portion of its length.

10. The blinds of claim 6 wherein said at least one fin is curved along at least a portion of its length.

11. A window-covering apparatus comprising a plurality of parallel louvers configured for being simultaneously tilted to selectively interrupt and pass light entering the window, each such louver having a cross-section providing a middle section at least a portion of which is planar and opposed continuous fins extending at an obtuse angle from said middle section to increase the deflection properties of said louver and increase the light blocking aspect of said plurality of louvers when tilted to interrupt light.

12. The window covering apparatus of claim 11 further comprising a head-rail having a face that has substantially the same cross-section as said louvers.

13. The window covering apparatus of claim 11 further comprising a bottom rail having a nesting surface shaped to conform to the cross-section of said louvers.

14. The window covering apparatus of claim 11 wherein said opposed fins are of substantially the same size and shape.

15. The window covering apparatus of claim 11 wherein said opposed fins are of different size.

16. The window covering apparatus of claim 11 wherein said opposed fins are of different shape.

17. The window covering apparatus of claim 11 wherein at least one of said opposed fins is tapered along at least a portion of its length.

18. The window covering apparatus of claim 11 wherein said opposed fins extend integrally from opposite elongated edges of said middle section.

19. The window covering apparatus of claim 11 wherein said louvers are substantially horizontal.

20. The window covering apparatus of claim 11 wherein said louvers are substantially vertical.

21. The window covering apparatus of claim 11 wherein said louvers are interconnected to form blinds.

22. The window covering apparatus of claim 11 wherein said louvers are interconnected to form shutters.

23. The window covering apparatus of claim 11 wherein each of said louvers has notches along its respective fins for receiving ladder-like members supporting said louvers in a tiltable orientation and a cord notch for channeling a control cord for selectively nesting said louvers.

24. The window covering recited in claim 11 wherein the middle section of each said louver has a portion which is curved.

25. The window covering recited in claim 11 wherein at least one of said fins is tapered along at least a portion of its length.

26. A window-covering apparatus comprising a plurality of parallel louvers configured for being simultaneously tilted to selectively interrupt and pass light entering the window, each such louver having a cross-section providing a middle section at least a portion of which is curved and opposed continuous fins extending at an obtuse angle from said middle section to increase the deflection properties of said louver and increase the light blocking aspect of said plurality of louvers when tilted to interrupt light.

27. The window covering apparatus of claim 26 further comprising a head-rail having a face that has substantially the same cross-section as said louvers.

28. The window covering apparatus of claim 26 further comprising a bottom rail having a nesting surface shaped to conform to the cross-section of said louvers.

29. The window covering apparatus of claim 26 wherein said opposed fins are of substantially the same size and shape.

30. The window covering apparatus of claim 26 wherein said opposed fins are of different size.

31. The window covering apparatus of claim 26 wherein said opposed fins are of different shape.

32. The window covering apparatus of claim 26 wherein at least one of said opposed fins is tapered along at least a portion of its length.

33. The window covering apparatus of claim 26 wherein said opposed fins extend integrally from opposite elongated edges of said middle section.

34. The window covering apparatus of claim 26 wherein said louvers are substantially horizontal.

35. The window covering apparatus of claim 26 wherein said louvers are substantially vertical.

36. The window covering apparatus of claim 26 wherein said louvers are interconnected to form blinds.

37. The window covering apparatus of claim 26 wherein said louvers are interconnected to form shutters.

38. The window covering apparatus of claim 26 wherein each of said louvers has notches along its respective fins for receiving ladder-like members supporting said louvers in a tiltable orientation and a cord notch for channeling a control cord for selectively nesting said louvers.

39. The window covering recited in claim 26 wherein the middle section of each said louver has a portion which is planar.

40. The window covering recited in claim 26 wherein at least one of said fins is tapered along at least a portion of its length.
